(19) United States
(12) Patent Application Publication
(10) Pub. No.: US 2011/0289838 A1
(43) Pub. Date: Dec. 1, 2011

(54) REUSABLE PLANT CONTAINER APPARATUS

(76) Inventor: TRINON CIRELLO, Costa Mesa, CA (US)

(21) Appl. No.: 12/786,714

(22) Filed: May 25, 2010

(51) Int. Cl. A01G 9/02

(52) U.S. Cl. 47/65.7; 47/73

(57) ABSTRACT

The invention is a plant container for growing and transplanting plants. More, specifically, the invention is for a plant container that is made of a multi-layered heat pressed root impenetrable materials with a plurality of closure mechanisms that allows a user to more easily remove and transplant a plant as well as monitor plant root growth.

### PRIORITY NOTICE

The present application claims priority under 35 U.S.C. §120 to U.S. patent application Ser. No. 12/732,957 filed on Mar. 26, 2010, the disclosure of which is incorporated herein by reference in its entirety.

### TECHNICAL FIELD OF THE INVENTION

The present invention relates in general to a container for growing and transplanting plants, and more specifically, to a heat pressed multi-layered root impenetrable container with a plurality of closure mechanisms that allows a user to more easily remove and transplant a plant as well as monitor plant root growth.

### COPYRIGHT & TRADEMARK NOTICE

A portion of the disclosure of this patent application may contain material that is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and shall not be construed as descriptive or to limit the scope of this invention to material associated only with such marks.

### BACKGROUND OF THE INVENTION

As is well known in the industry, plant nurseries use containers not only to transport plants, but to keep and grow plants so that they may be sold at a moment's notice. In addition to portability, plant containers need to facilitate the healthy long term growth of plants while allowing for the plants to be eventually taken out of the container without damage to the roots.

A key limitation of modern plant containers is that they restrict the volume that roots can grow in. Roots in soil generally grow to a length that is double the height of the plant itself. Plant containers, on the other hand, are much smaller than the plant itself and this restricts root growth when they reach the container wall by either deflecting the roots or stopping root growth completely. The use of simple solid containers results in root growth that circle around the inside of the containers. Such root circling is best avoided as it acts to the detriment of a plant's long term health.

Common techniques involve using a material on the inner side of the container that either kills the root on contact or traps the root in place so that it can't grow any further. Still, these techniques limit root growth to a fixed volume and result in smaller than average sized roots.

In addition to facilitating healthy root growth, plant containers also need to protect plants from extreme outside elements such as heat, cold, and UV light. However, this protection from the outside needs to be mitigated with the plant's need to grow in oxygen rich soil and have access to water. Plant containers that protect too much from outside elements will invariably cut the soil off from oxygen and hinder plant growth. Water permeable containers partially replenish oxygen by allowing oxygen deficient water to drain from the container as oxygen rich water takes its place.

Factors such as ease of use, durability, storage space, and cost of materials are also important in assessing the value of a container. Modern plant containers not only need to facilitate healthy root growth and protect roots from the elements, but also need to be practical to use. The ideal plant containers are reusable, take up little space, and are cost effective. Heavy plants need to be lifted several feet to be placed into and taken out of plant containers. Lifting plants from their containers not only places a large burden on those moving the plant, but also poses a risk to the plant itself as the movement can potentially damage sensitive roots that are not meant to be moved or handled.

Sometimes, containers are disassembled or destroyed to remove plants from them in order to prevent damage to the roots. Substantial cost is then incurred in the reassembly or purchase of a new container. Thus, removing plants from their containers is done sparingly even though it may be advantageous for growers to occasionally transport the plant to a new container or monitor a plant's root growth by temporarily removing it from a container.

There is a need in the art for a container for growing and transplanting plants. Specifically, there is a need for a device that has a multi-layered root impenetrable container with a plurality of closure mechanisms that allows a user to more easily remove and transplant a plant as well as monitor plant root growth. It is to these ends that the present invention has been developed.

### SUMMARY OF THE INVENTION

To minimize the limitations in the prior art, and to minimize other limitations that will be apparent upon reading and understanding the present specification, the present invention describes an improved plant container made of root impenetrable material and containing one or more closure mechanisms.

An apparatus for containing a plant, in accordance with the present invention, comprising a structure formed by a multi-layered root impenetrable material, wherein each layer of said multi-layered root impenetrable material is heat bonded together, and a plurality of closure mechanisms located around an opening on said structure.

An apparatus for containing a plant, in accordance with the present invention, comprising a cylindrical structure formed by a multi-layered root impenetrable material, wherein said multi-layered root impenetrable material further comprising an inner layer and an outer layer, and wherein said inner and outer layers are attached together via a heat press process, and a plurality of closure mechanisms positioned vertically on an opening of said cylindrical structure, wherein said plurality of closure mechanisms further comprise hook and loop fastener attachments.

An apparatus for containing a plant, in accordance with the present invention, comprising a cylindrical structure formed by a multi-layered root impenetrable material, wherein said multi-layered root impenetrable material further comprises an inner layer and an outer layer that are heat bonded together, and wherein said heat bonded inner and outer layers are needle-punched, and a plurality of closure mechanisms positioned vertically on an opening of said cylindrical structure, and an expandable root impenetrable material attached on an inner side of said cylindrical structure and on opposite sides of said opening.

It is an objective of the present invention to provide a plant container that affords the advantages of root trapping material, UV protection, and water permeability with the use of a lightweight cloth that offers both structural support and flexibility.

It is another objective of the present invention to provide a re-sealable plant container so that plants can be extricated with the utmost ease without comprising the usability of the container.

It is another objective of the present invention to provide a re-sealable plant container so that plants can be inspected for root growth progress and growth stability.

It is another objective of the present invention to provide a re-sealable plant container with enhanced aerating characteristics in addition to those of the material used to construct the plant container.

Finally, it is yet another objective of the present invention to provide a light and collapsible plant container to minimize transportation and storage cost.

These and other advantages and features of the present invention are described herein with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1(a) is a perspective view of an exemplary embodiment of the present invention depicting a plant container apparatus holding a sapling and potting soil within it.

FIG. 1(b) is enlarged front view of FIG. 1(a), specifically depicting a principal closure mechanism of the plant container apparatus in a partially open position and with the roots of the sapling in view.

FIG. 1(c) is a top view of FIG. 1(a) and (b), but without the sapling and surrounding soil, and which (a) depicts an inner protective flap as well as an outer secondary closure mechanism shown in outward positions and that are located adjacent to the inner and outer edges of the principal closure mechanism; and (b) also depicts inner and outer material layers of the container apparatus.

FIG. 2 is a perspective view of an exemplary embodiment of the present invention showing the principal and secondary closure mechanisms in a full open position.

FIG. 3 is an illustration of FIG. 2, but also depicting a user removing the sapling and surrounding soil from the container apparatus.

FIG. 4(a) is a top perspective view of an alternative embodiment of the present invention.

FIG. 4(b) is another top perspective view of this alternative embodiment, but which depicts an inner and outer closure mechanism both shown in outward open positions and that can be attached on each side of inner and outer end regions of the container apparatus.

FIG. 5 is yet another embodiment of the present invention, which depicts the closure mechanisms of the apparatus in a limited open position that is held by an inner expandable segment.

### DETAILED DESCRIPTION OF THE DRAWINGS

In the following discussion that addresses a number of embodiments and applications of the present invention, reference is made to the accompanying drawings that form a part hereof, where depictions are made, by way of illustration, of specific embodiments in which the invention may be practiced. It is to be understood that other embodiments may be utilized and changes may be made without departing from the scope of the present invention.

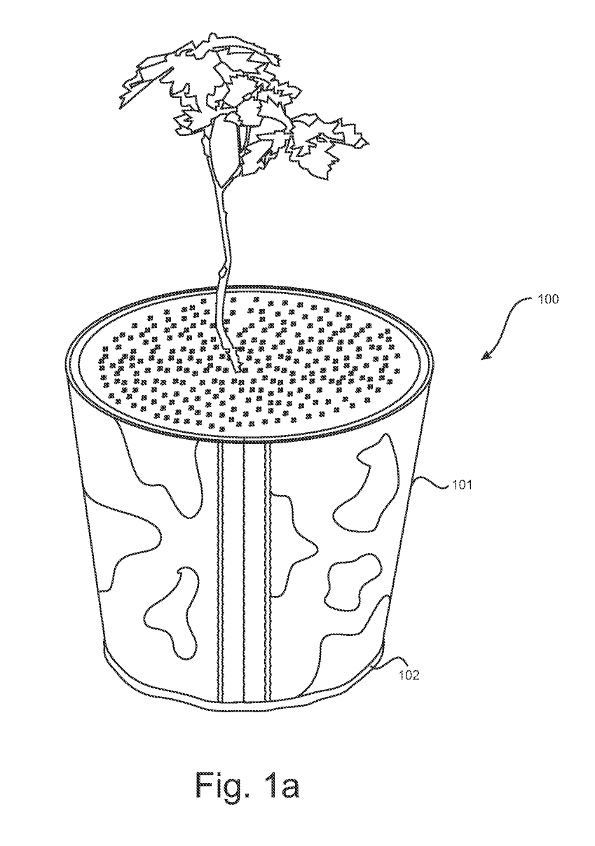

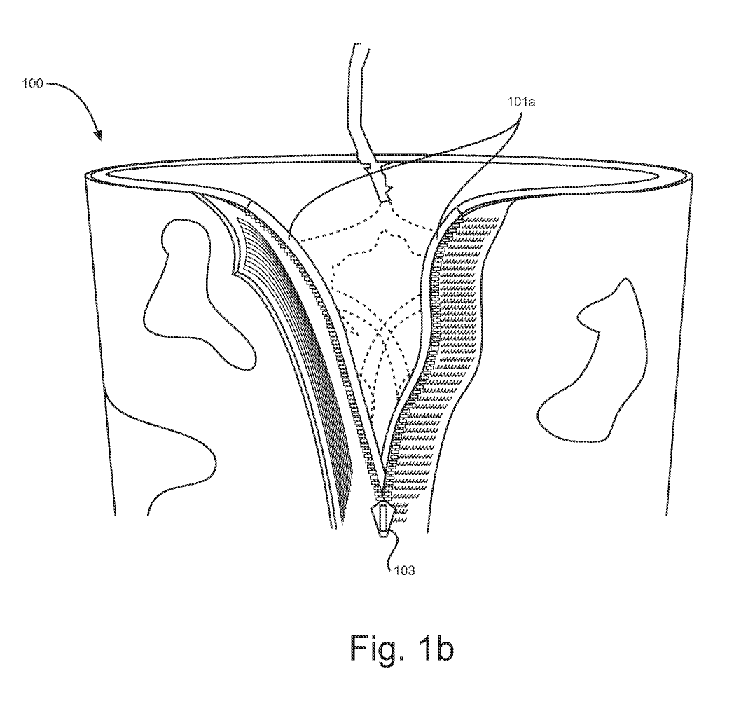

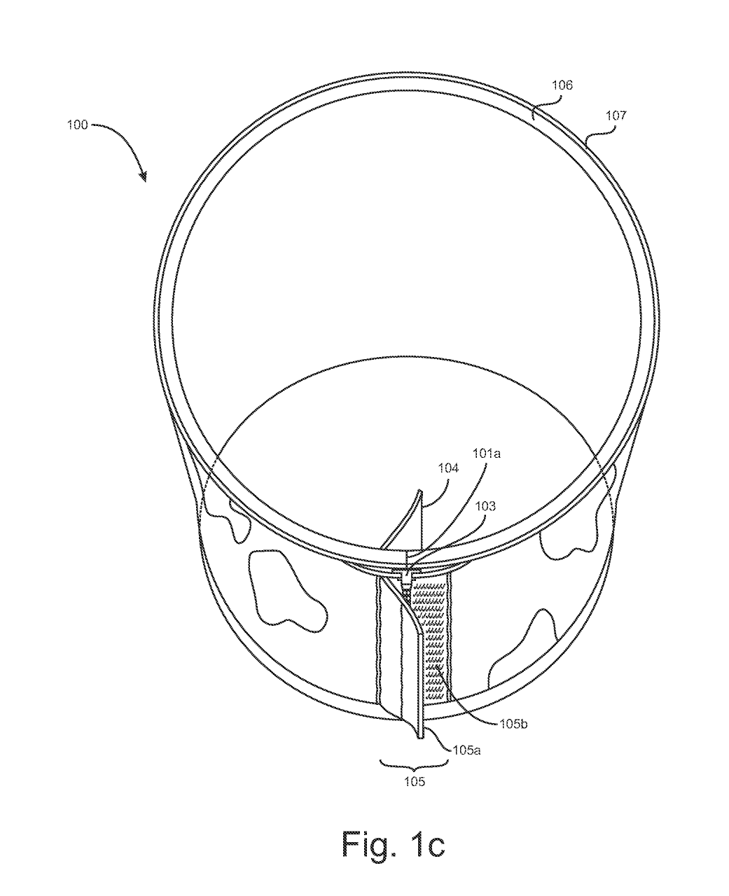

As set forth above, FIG. 1(a) is a perspective view of an exemplary embodiment of the present invention depicting a plant container apparatus holding a sapling and surrounding potting soil within it. In the exemplary embodiment, plant container apparatus 100 comprises a cylindrical body 101 with a bottom enclosure 102 on one end of the cylindrical body 101. Principal closure mechanism 103 (not shown in this view) is located vertically along an opening 101a (not shown in this view) of cylindrical body 101 and perpendicular to bottom enclosure 102.

FIG. 1(b) is enlarged front view of FIG. 1(a), specifically depicting the principal closure mechanism 103 of the plant container apparatus 100 in a partially open position and with the roots of the sapling in view. When a user desires to transplant or move a plant out of plant container apparatus 100 via opening 101a, principal closure mechanism 103 may be opened in full, or in part, as is depicted here. Furthermore, principal closure mechanism 103 allows a user to open plant container apparatus 100 and inspect the root growth of a plant, thus enabling the user to monitor and track the root growth stability of the plant.

In the exemplary embodiment, principal closure mechanism 103 is a zipper, or zip fastener. In particular, the zipper or zip fastener is made of brass metal material because of its durability and impermeability characteristics, which allow it to better withstand any of the zipper's exposure to water, soil and other organic components. While the exemplary embodiment's zipper is made of brass, this should not be interpreted as limiting the scope of the present invention. The zipper or zip fastener can be made of any other material that allows it to withstand the possibility of continued exposure to water, soil and other organic elements.

FIG. 1(c) is a top view of FIG. 1(a) and (b), but without the sapling and surrounding soil, and which (a) depicts an inner protective flap 104 as well as an outer secondary closure mechanism 105 shown in outward positions and that are located adjacent to the inner and outer edges of the principal closure mechanism 103; and (b) also depicts inner and outer material layers of the container apparatus.

As explained above, the principal closure mechanism 103 allows a user to open the plant container apparatus 100 for various reasons, such as transplanting or monitoring a plant. Behind the principal closure mechanism 103 is an inner protective flap 104 that is attached adjacent to one side of opening 101a and on the back side of the principal closure mechanism 103 and that protects it from exposure to water, soil and other types of debris contained within the plant container apparatus 100. As will be explained later, inner protective flap 104 may be made of the same material as the inner layer of plant container apparatus 100. Further, inner protective flap 104 rests behind principal closure mechanism 103 in a vertical position and has a width that is large enough to adequately cover the rear side of principal closure mechanism 103. Inner protective flap 104 may simply rest as a supportive means behind principal closure mechanism 103 or may have an attaching mechanism for fastening it securely behind principal closure mechanism 103. For example, inner protective flap 104 may have a hook and loop fastener so that it can be secured more firmly into place behind principal closure mechanism 103.

In addition to principal closure mechanism 103 there is a secondary closure mechanism 105 that covers the front side of principal closure mechanism 103. In the exemplary embodiment, secondary closure mechanism 105 contains an outer loop flap 105a of the hook and loop fastener layer. This outer loop flap 105a is located vertically in front of and attached adjacently to one side of opening 101a and the front side of principal closure mechanism 103. Secondary closure mechanism 105 also contains a inner hook layer 105b located on the body of plant container apparatus 100, and that is located in a vertical position and on the opposite side of opening 101a and principal closure mechanism 103.

Secondary closure mechanism 105 not only provides protection from exposure for the front side of principal closure mechanism 103, but provides an additive means of relieving any stress and force on principal closure mechanism 103. By relieving the stress and force on principal closure mechanism 103, secondary closure mechanism 105 provides increased durability, stability and longevity of life of plant container apparatus 100.

FIG. 1(c) also depicts the inner and outer material layers of plant container apparatus 100. Plant container apparatus 100 contain an inner layer 106 and an outer layer 107. In the exemplary embodiment, inner layer 106 is comprised of a root impenetrable material, such as a geotextile. A geotextile is used in the exemplary embodiment of the present invention due to its advantages when used with soil, such as separation, drainage, filtration, reinforcement and cushioning properties. While geotextiles range in nature and characteristics, plant container apparatus 100 can be made from any of polypropylene or polyester fabrics that are woven, needle punched or heat bonded together.

Plant container apparatus 100 also has outer layer 107. In the exemplary embodiment of the present invention, outer layer 107 is made of a UV protective polyester material. Outer layer 107 is bonded to inner layer 106 by a heat pressing or bonding process that attaches the two layers together by the use of heat and pressure. Using a UV protective cloth as outer layer 107 provides an additional level of protection to a plant and its surrounding soil contained within plant container apparatus 100. Also in the exemplary embodiment, outer layer 107 is made from a polyester material that has a camouflage-like pattern, with colors such as dark and light green, brown, black and tan. The use of a dark pattern and colors not only provides a natural and ecological-like look to plant container apparatus 100 but provides for a higher level of UV protection because they can block more harmful UV rays. The use of earth color tones assists in plant container apparatus 100 to release more heat than a plant container that is black in color. Furthermore, outer layer 107 can be made from a polyester material since the properties of polyester are especially conducive to adequately attaching it to inner layer 106 through the heat pressing process.

As mentioned above, inner layer 106 and outer layer 107 are heat pressed or bonded together for purposes of permanently attaching the two layers to each other. A heat pressing process is used in order to maintain the integrity of inner layer 106 and outer layer 107 without the introduction of an adhesive substance that could negatively affect the targeted properties of each layer, as explained above. Any appropriate heat pressing or bonding process commonly known in the art can be used to attach inner layer 106 and outer layer 107 to each other without deviating from the scope of the present invention. Once inner and outer layers 106 and 107 are attached together, the layers are needle-punched in order to enhance the overall aerating characteristics plant container apparatus 100, in addition to those already present in inner layer 106. In addition, any needle-punching process commonly known in the art can be used to needle-punch the permanently bonded inner and outer layers 106 and 107.

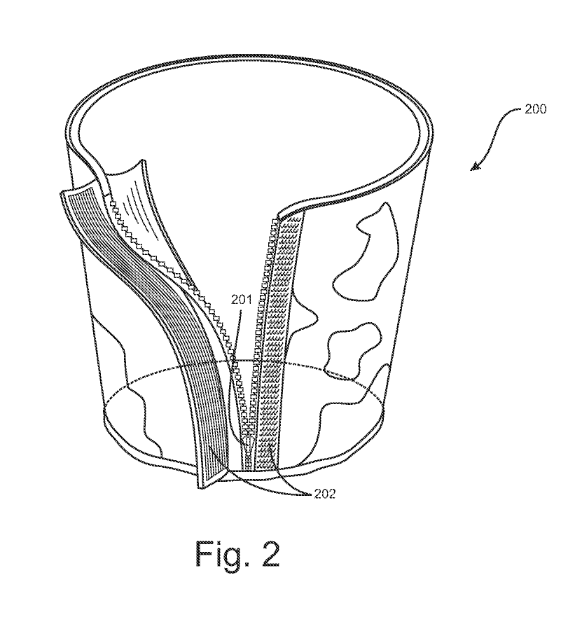

FIG. 2 is a perspective view of the exemplary embodiment of the present invention showing the principal and secondary closure mechanisms (labeled as 201 and 202, respectively, in this figure) in a full open position. When a user opens plant container apparatus 200 in order to transplant a sapling or other type of plant, closure mechanisms 201 and 202 allow for a wide opening. This enables a user to open plant container apparatus 200 enough to remove it from and peel it away from the plant and its surrounding soil. By opening plant container apparatus 200 in such a way due to closure mechanisms 201 and 202, a user has increased flexibility in removing the container from the plant with little to no damage to the plant and without having to cut or rip into pieces plant container apparatus 200. As a result, closure mechanisms 201 and 202 complement plant container apparatus 200 in that it enables it to be reused.

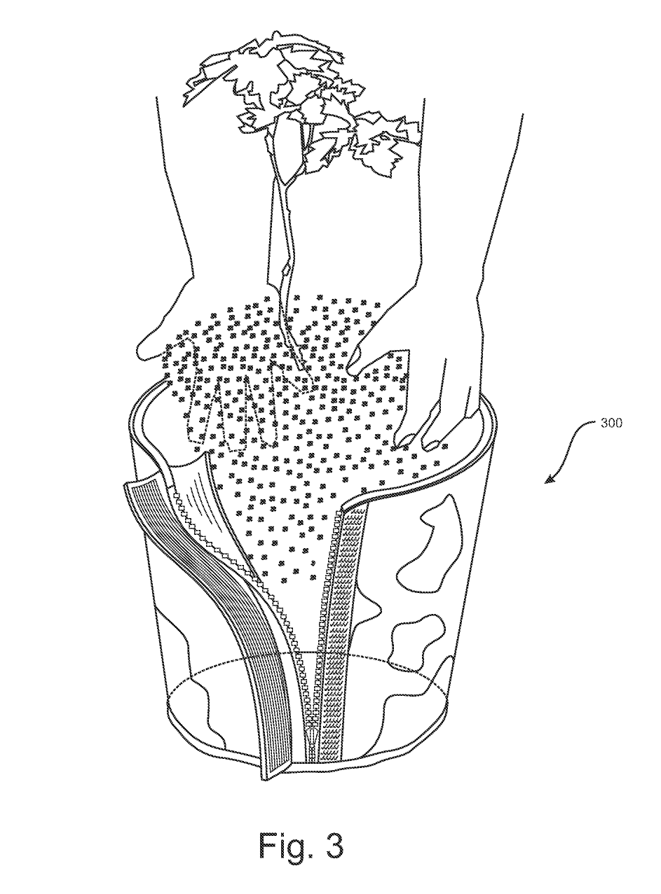

FIG. 3 is an illustration of FIG. 2, but also depicting a user removing the sapling and surrounding soil from the container apparatus. As previously explained, a user can more easily peel plant container apparatus 300 away from the plant and its surrounding soil with little to no damage to the plant and without having to cut or rip into pieces plant container apparatus 300. This of course allows for increased protection and stability of a plant during the transplant process.

As mentioned earlier, the closure mechanisms may also be used while monitoring the growth of a plant in the plant container apparatus 300. In particular, a user may want to monitor root growth of the plant to ensure that the roots are growing properly or are otherwise in healthy condition. By using the closure mechanisms, a user can also move the plant by sliding it horizontally within the plant container apparatus 300. This may be done if the user desires to inspect another section of root growth of the plant.

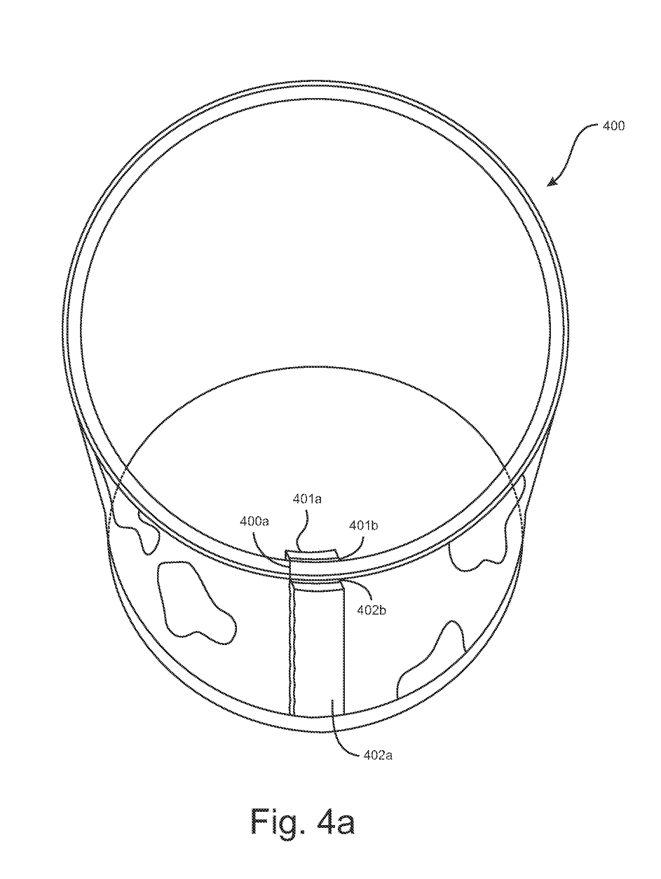

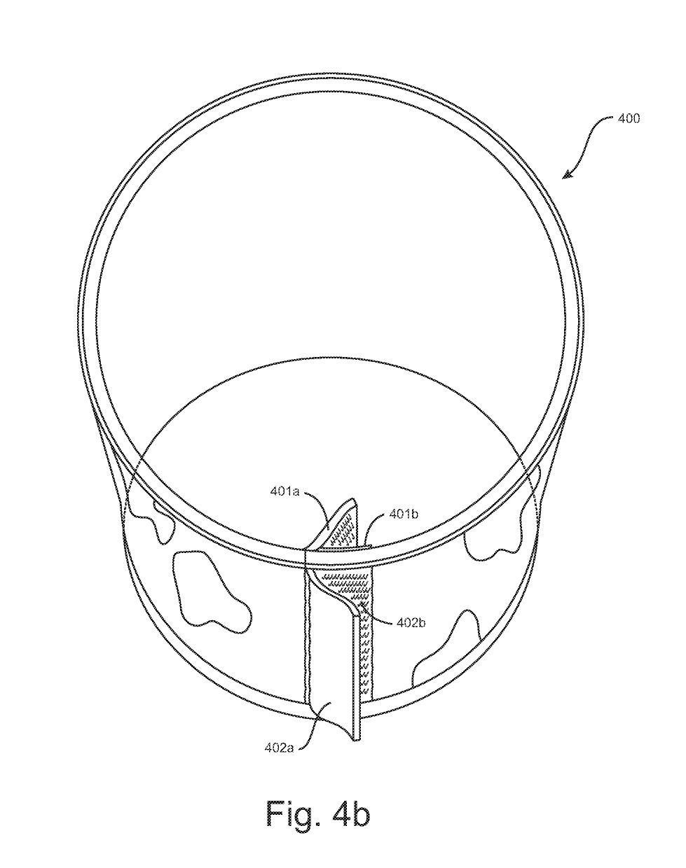

FIG. 4(a) is a top perspective view of an alternative embodiment of the present invention. In this embodiment, a plurality of closure mechanisms is used to open and seal plant container apparatus 400, namely two hook and loop fastener attachments around opening 400a. In this embodiment, there is an inner loop flap 401a and outer loop flap 402a, each located on one side of opening 400a and that adheres to inner and outer hook end regions, 401b and 402b, respectively, located on the opposite side of opening 400a and on the body of plant container apparatus 400. Both inner and outer loop flaps 401a and 402a are located in a vertical position to correspond to inner and outer end hook regions 401b and 402b, which are also vertically positioned around opening 400a of plant container apparatus 400.

Both inner and outer loop flaps 401a and 402a may be positioned adjacently next to each other so as to form a V-like shape. In preparing to use this embodiment of plant container apparatus 400, a user may attach inner loop flap 401a to its mate, inner hook end region 401b, and then attach outer loop flap 402a to its mate, outer hook end region 402b. While inner and outer loop flaps 401a and 402a may be positioned in a V-like shape, this should not be interpreted as limiting the scope of the variations possible for how inner and outer loop flaps 401a and 402a may be fashioned in attaching to plant container apparatus 400.

FIG. 4(b) is another top perspective view of this alternative embodiment, but which depicts an inner and outer loop flaps 401a and 402a, which are both shown in outward open positions and that can be attached on each side of inner and outer hook end regions (401b and 402b) of the plant container apparatus 400. As with the previous embodiment, having a plurality of closure mechanisms, inner and outer loop flaps 401a and 402a, provide the plant container apparatus 400 with additional force and strength to withstand the plant, its surrounding soil, water supplied to the plant, and the plant's natural growth.

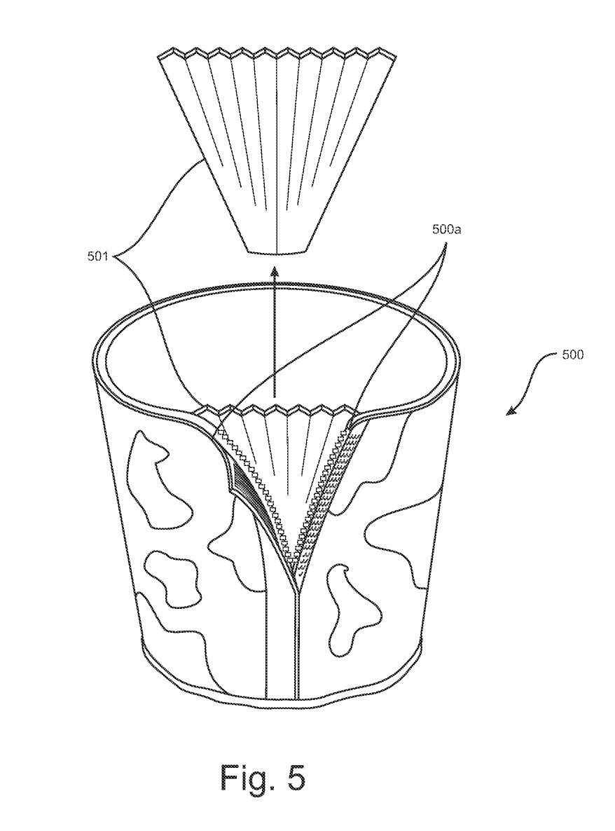

FIG. 5 is yet another embodiment of the present invention, which depicts the closure mechanisms of the apparatus in a limited open position that is held by an inner expandable segment. This particular embodiment may contain either of the closure mechanisms as described in the two previous embodiments. However, this should not be interpreted as limiting the scope of the present invention and the use of the inner expandable segment in conjunction with different types of closure mechanisms and the variations thereof.

In this embodiment of plant container apparatus 500, there is attached behind the plurality of closure mechanisms an inner expandable segment 501. In the exemplary embodiment of the inner expandable segment 501, it is substantially shaped as a V-shaped segment with each side of the V-shape attached near each inner side of an opening 500a of plant container apparatus 500. In order to protect root growth of a plant inside plant container apparatus 500, inner expandable segment 501 is made of a geotextile, similar to the inner layer 106 (described in FIG. 1 above). While inner expandable segment 501 comprises a geotextile, it should be a geotextile that is adequately flexible in nature to allow it to compress and expand as needed. For instance, when plant container apparatus 500 is sealed by its closure mechanisms, inner expandable segment 501 will likewise be in a compressed state. In one embodiment of inner expandable segment 501, its compressed state is a geotextile in a preformed accordion-like shape that is able to expand and stretch out horizontally when the closure mechanisms are opened by a user.

Inner expandable segment 501 allows for a user to open the closure mechanisms of plant container apparatus 500 in part or in full to permit for the expansion and growth of a plant before a full transplant process. This provides an alternative to moving the plant to another larger container or for planting in the earth in the event that the plant is not yet ready for a complete transplantation.

A multi-layered root impenetrable container with a plurality of closure mechanisms that allows a user to more easily remove and transplant a plant as well as monitor plant root growth has been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching. It is intended that the scope of the invention not be limited by this detailed description, but by the claims and the equivalents to the claims.

What is claimed is:

1. An apparatus for containing a plant comprising:
a structure formed by a multi-layered root impenetrable material;
wherein each layer of said multi-layered root impenetrable material is heat bonded together; and
a plurality of closure mechanisms located around an opening on said structure.

2. The apparatus of claim 1, wherein said structure formed by said multi-layered root impenetrable material is substantially cylindrical.

3. The apparatus of claim 2, wherein said structure has a bottom closure portion on one end of said substantially cylindrical multi-layer impenetrable material.

4. The apparatus of claim 1, wherein said multi-layered root impenetrable material is water permeable.

5. The apparatus of claim 1, wherein said multi-layered root impenetrable material comprises an inner layer and an outer layer.

6. The apparatus of claim 5, wherein said inner layer is further comprised of a geotextile.

7. The apparatus of claim 6, wherein said inner layer is further comprised of a polypropylene fabric material.

8. The apparatus of claim 7, wherein said outer layer is further comprised of polyester material.

9. The apparatus of claim 8, wherein said outer layer is further comprised of UV protective material.

10. The apparatus of claim 9, wherein said UV protective fabric comprises a plurality of dark colors.

11. The apparatus of claim 10, wherein said plurality of dark colors form a substantially camouflage pattern.

12. The apparatus of claim 5, wherein said heat pressed inner and outer layers are needle-punched.

13. The apparatus of claim 2, wherein said opening and said plurality of closure mechanisms are positioned vertically on said substantially cylindrical structure.

14. The apparatus of claim 13, wherein said plurality of closure mechanisms further comprises:
a zipper; and
a hook and loop fastener attachment.

15. The apparatus of claim 14, wherein said zipper is comprised of brass metal.

16. The apparatus of claim 14, wherein said zipper is protected by an inner material flap that is attached adjacent to and behind said zipper within said substantially cylindrical structure.

17. The apparatus of claim 14, wherein said hook and loop fastener attachment protects the front side of said zipper.

18. The apparatus of claim 17, wherein said hook and loop fastener attachment further comprises a loop layer that is located adjacent to the front side of said zipper and a hook layer located on said substantially cylindrical structure and adjacent to the opposite front side of said zipper.

19. An apparatus for containing a plant comprising:
a cylindrical structure formed by a multi-layered root impenetrable material;
wherein said multi-layered root impenetrable material further comprising an inner layer and an outer layer; and
wherein said inner and outer layers are attached together via a heat press process; and
a plurality of closure mechanisms positioned vertically on an opening of said cylindrical structure;
wherein said plurality of closure mechanisms further comprise hook and loop fastener attachments.

20. The apparatus of claim 19, wherein said heat pressed inner and outer layers are needle-punched.

21. The apparatus of claim 19, wherein said hook and loop fastener attachments further comprise two loop layers located on one side of said opening on said cylindrical structure.

22. The apparatus of claim 21, wherein said two loop layers further comprises an inner loop layer that may extend into an area within said cylindrical structure and an outer loop layers that may extend into an area outside of said cylindrical structure.

23. The apparatus of claim 22, wherein said hook and loop fastener attachments further comprise two hook layers located on the opposite side of said opening on said cylindrical structure.

24. The apparatus of claim 23, wherein said two hook layers further comprises an inner hook layer that is located on the inner side of said opening on said cylindrical structure and an outer hook layer that is located on the outer side of said opening on said cylindrical structure.

25. An apparatus for containing a plant comprising:
a cylindrical structure formed by a multi-layered root impenetrable material;
wherein said multi-layered root impenetrable material further comprises an inner layer and an outer layer that are heat bonded together; and
wherein said heat bonded inner and outer layers are needle-punched; and
a plurality of closure mechanisms positioned vertically on an opening of said cylindrical structure; and
an expandable root impenetrable material attached on an inner side of said cylindrical structure and on opposite sides of said opening.
